(19) United States
(12) Patent Application Publication
(10) Pub. No.: US 2026/0350420 A1
(43) Pub. Date: Nov. 5, 2026

(54) AGENTIC-AI DRIVEN DYNAMIC COMPOSITION OF ANALYTIC ARTIFACTS IN A COMPOSABLE PLATFORM

(71) Applicant: FAIR ISAAC CORPORATION, Minneapolis, MN (US)

(72) Inventors: Sean Justin Baseman, Los Angeles, CA (US); Christopher Schultz, Eagan, MN (US); Prashant Jamkhedkar, Fremont, CA (US)

(21) Appl. No.: 19/662,268

(22) Filed: Apr. 29, 2026

Related U.S. Application Data
(60) Provisional application No. 63/799,068, filed on May 2, 2025.

(51) Int. Cl. G06N 5/01; G06N 5/02

(52) U.S. Cl. CPC G06N 5/01; G06N 5/02

(57) ABSTRACT

A method in a composable platform architecture, comprising: deriving constraints and constructing a feature set from one or more qualified trigger events; traversing a knowledge graph representing interconnected modular assets to identify one or more assets based on the derived constraints and constructed feature set; composing an analytic artifact based on the identified assets, wherein the analytic artifact comprises a decisioning artifact, an optimization artifact, or a simulation artifact; executing the composed analytic artifact to simulate an outcome; and generating a recommendation based on the outcome.

### CROSS REFERENCE

This application claims priority under 35 U.S.C. § 119 to U.S. Provisional Patent Application No. 63/799,068 filed on May 2, 2025, the entire contents of which is hereby expressly incorporated by reference herein.

### TECHNICAL FIELD

The subject matter described herein relates to intelligent platform architectures, specifically to systems and methods for agentic-AI driven composable platforms that dynamically manage and generate analytic artifacts in response to external and internal events.

### BACKGROUND

In various industries, such as finance, insurance, and e-commerce, organizations increasingly rely on digital decisioning, optimization, and simulation models to adapt to rapidly shifting market conditions and customer demands. Traditional systems often require manual creation and updating of models, rules, and analytic processes, leading to significant inefficiencies when external events or internal operational changes occur. This manual dependency hampers the speed of response, limits scalability, and increases operational risk during periods of rapid change.

Existing approaches to decision-making and optimization frequently involve siloed analytic components, rigid workflows, or static model architectures that do not readily accommodate dynamic contextual shifts. As a result, organizations often struggle to update or adapt their decisioning strategies in response to external signals such as economic fluctuations, regulatory changes, or evolving customer behaviors. This lack of flexibility can lead to suboptimal outcomes, delayed responses to critical events, and missed opportunities for optimization and risk mitigation.

There is a need for an improved platform architecture that enables modular, flexible, and context-aware management of decisioning, optimization, and simulation capabilities, for example, by way of agentic-AI assisted platform tools. Such a platform would facilitate dynamic adaptation to external and internal triggers without requiring extensive manual reengineering, thereby improving the speed, scalability, and resilience of organizational decision-making processes across a variety of operational domains.

### SUMMARY

Methods, systems, and articles of manufacture, including computer program products, are provided for a method in a composable platform architecture, comprising: deriving constraints and constructing a feature set from one or more qualified trigger events; traversing a knowledge graph representing interconnected modular assets to identify one or more assets based on the derived constraints and constructed feature set; composing an analytic artifact based on the identified assets, wherein the analytic artifact comprises a decisioning artifact, an optimization artifact, or a simulation artifact; executing the composed analytic artifact to simulate an outcome; and generating a recommendation based on the outcome

In another aspect, there is provided a computer program product including a non-transitory computer readable medium storing instructions that, when executed by at least one programmable processor, cause the at least one programmable processor to perform operations. The operations include: deriving constraints and constructing a feature set from one or more qualified trigger events; traversing a knowledge graph representing interconnected modular assets to identify one or more assets based on the derived constraints and constructed feature set; composing an analytic artifact based on the identified assets, wherein the analytic artifact comprises a decisioning artifact, an optimization artifact, or a simulation artifact; executing the composed analytic artifact to simulate an outcome; and generating a recommendation based on the outcome.

In another aspect, there is provided a system comprising: a programmable processor; and a non-transient machine-readable medium storing instructions that, when executed by the processor, cause the at least one programmable processor to perform operations. The operations include: deriving constraints and constructing a feature set from one or more qualified trigger events; traversing a knowledge graph representing interconnected modular assets to identify one or more assets based on the derived constraints and constructed feature set; composing an analytic artifact based on the identified assets, wherein the analytic artifact comprises a decisioning artifact, an optimization artifact, or a simulation artifact; executing the composed analytic artifact to simulate an outcome; and generating a recommendation based on the outcome.

Implementations of the current subject matter can include, but are not limited to, methods consistent with the descriptions provided herein as well as articles that include a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system architecture, in accordance with one or more embodiments of the approach described herein.

FIG. 2 illustrates an exemplary flow diagram depicting a dynamic event-driven analytic artifact generation and simulation process, in accordance with one or more embodiments of the approach described herein.

FIG. 3 illustrates an exemplary sequence diagram depicting inter-module interactions for dynamic event-driven analytic artifact generation and decisioning, in accordance with one or more embodiments of the approach described herein.

FIG. 4 is a diagram illustrating a flow chart of a process 400 for dynamically generating analytic artifacts and deriving decision recommendations, in accordance with one or more embodiments of the approach described herein.

FIG. 5 depicts a block diagram illustrating a computing system consistent with implementations of the current subject matter.

When practical, like labels are used to refer to same or similar items in the drawings.

### DETAILED DESCRIPTION

The details of one or more variations of the subject matter described herein are set forth in the accompanying drawings.

The present disclosure relates to a modular and composable platform architecture configured to facilitate integration across a plurality of business capabilities, including decisioning, analytics, optimization, and data management. This architecture is enabled by declarative protocols and flexible asset management. In some embodiments, the declarative protocols are those that set standardized rules for how assets interact within the platform, specifying interaction semantics, versioning, and compliance parameters to ensure seamless integration. The platform incorporates standardized protocol semantics, modular components, and multi-tenant management strategies to address complex business requirements, providing enhanced scalability and operability. Monolithic architectures typically experience significant strain on system resources due to tightly coupled dependencies, which can cause loading and response delays. In such systems, even minor updates can lead to cascading effects across multiple modules, creating bottlenecks and increasing deployment complexity. In some embodiments, the composable platform capability provides a foundational architecture for implementing declarative cross-cutting asset semantics to achieve flexible composition and standardized management of assets. This may include defining standardized interactions between assets, thereby enabling seamless integration of assets within the platform. The capability further includes a repository structure for asset storage and versioning, supporting multiple protocol versions to maintain compatibility between various iterations, thereby improving adaptability and scalability. The architecture may also facilitate flexible deployment of business function modules, enabling efficient management processes while maintaining high scalability. In some embodiments, the composable micro frontends capability implements a modular frontend architecture for the platform, utilizing micro frontends to build user interfaces. This capability may leverage declarative protocols and module federation to enable dynamic loading and composition of frontend components. The micro frontends capability further supports the loading and embedding of user interface components without necessitating a complete recompilation of the application, thus allowing for flexible customization and expansion of user interfaces. This architecture may enhance user experience by enabling the adjustment of frontend interactions according to specific requirements. In some embodiments, the multi-tenant capability provides strategies for managing multi-tenant environments and organizational hierarchies, allowing for secure and flexible asset management in multi-user settings. This capability may include defining hierarchical organizational structures that manage asset sharing and data isolation between tenants. It may further support tenant isolation to ensure the separation of data and business logic across different tenants, thus meeting data privacy and compliance requirements. Additionally, this capability may include configurable policies that support the customization of platform functionalities and access rights based on specific tenant requirements, facilitating adaptable and secure asset management in complex multi-tenant environments.

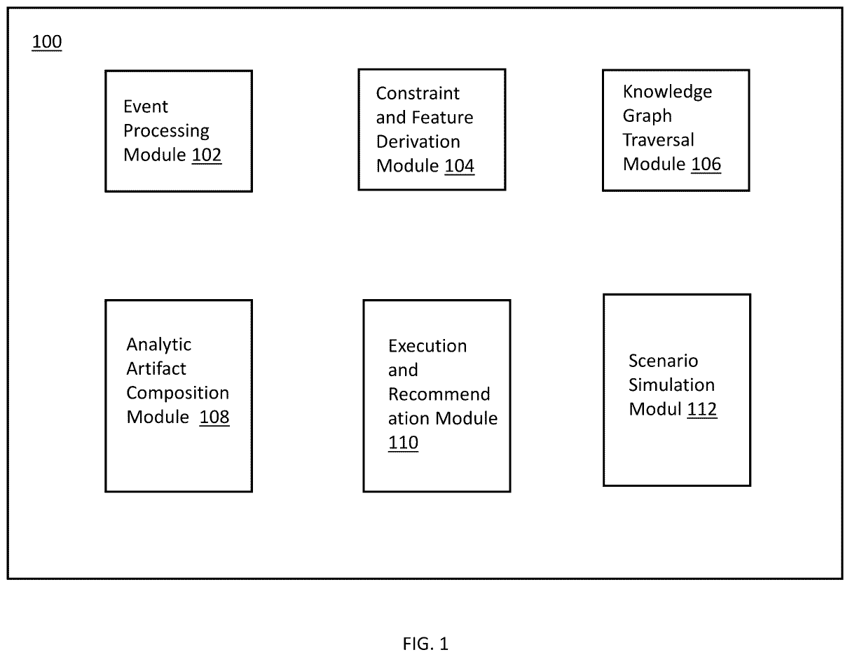

FIG. 1 illustrates an exemplary agentic-AI system 100, in accordance with one or more embodiments of the approach described herein. The system 100 may facilitate event-driven generation and management of analytic artifacts, for example, in response to external or internal trigger events. As shown in FIG. 1, the system 100 may include multiple modules that operate collaboratively to perform event processing, contextual analysis, asset traversal, artifact generation, simulation, and recommendation. In some embodiments, an event processing module 102 may be configured to receive and process one or more qualified trigger events. As used herein, a qualified trigger event may refer to an external or internal event meeting predefined criteria that initiate analytic processing workflows. The event processing module 102 may detect events such as economic indicators, market fluctuations, or operational anomalies, and generate event payloads to initiate further processing.

A constraint and feature derivation module 104 may be configured to derive decision-making constraints and construct a feature set based on the received event payload. In some embodiments, the constraint may refer to operational boundaries or conditions inferred from the context associated with the trigger event. Constraints may represent contextual limitations or operational requirements that govern how subsequent analytic artifacts are composed, executed, or evaluated. Constraints may define acceptable ranges, thresholds, mandatory conditions, or exclusionary criteria that must be considered when generating decisions, optimizations, or simulations in response to a trigger event. For example, the constraints may comprise maximum allowable shipment delays for perishable goods, minimum inventory thresholds for critical components in a manufacturing supply chain, or regulatory compliance limits for financial transactions triggered by updated interest rate policies. In some other examples, the constraints may comprise maximum allowable downtime for critical infrastructure following grid disruption events, environmental regulatory thresholds for emission levels during peak energy production, or minimum fuel reserve levels required to maintain operational stability under supply chain interruptions.

In some embodiments, a feature set may refer to a collection of relevant data attributes used to characterize the context. The feature set may represent quantitative or qualitative indicators that describe key aspects of the environment, system state, or operational conditions associated with a qualified trigger event. Features may include directly observed variables, derived metrics, or contextual factors that are selected to enable informed decision-making, optimization, or simulation processes. The feature set provides a structured input for subsequent analytic artifact generation and may influence how assets are identified, models are composed, or recommendations are derived. For example, the feature set may include attributes such as current inventory levels, shipment lead times, supplier reliability scores, financial exposure metrics, weather condition indices, or regulatory compliance statuses, depending on the operational domain and the nature of the trigger event.

The knowledge graph traversal module 106 may traverse a knowledge graph to identify one or more interconnected modular assets relevant to the derived constraints and constructed feature set. As used herein, a knowledge graph may refer to a data structure comprising interconnected nodes and edges, wherein each node represents a modular asset associated with metadata and each edge represents a defined relationship between two assets, enabling traversal, path discovery, and contextual reasoning. The knowledge graph provides a structured framework for representing operational entities, resource dependencies, logical relationships, and context-aware linkages among assets within the platform. Traversal of the knowledge graph may enable dynamic identification of impacted holdings, discovery of alternative pathways, prioritization of relevant assets based on contextual relevance scores, and support for adaptive analytic artifact generation in response to evolving operational conditions. For example, traversal of the knowledge graph may identify a set of shipment routes at risk due to a transportation disruption, discover alternative logistical pathways through unaffected hubs, prioritize available transportation modes based on real-time capacity and risk metrics, and facilitate the composition of a routing optimization artifact adapted to minimize delivery delays while balancing cost and resource utilization.

An analytic artifact composition module 108 may be configured to compose an analytic artifact based on the identified assets. In some embodiments, an analytic artifact may comprise a decisioning artifact, an optimization artifact, or a simulation artifact generated to address the context established by the trigger event. The analytic artifact may represent an executable or interpretable structure configured to support dynamic decision-making, operational optimization, or predictive simulation based on the selected assets and the derived contextual parameters. Composition of the analytic artifact may involve assembling relevant models, rulesets, datasets, or computational workflows into a coherent framework tailored to the specific operational scenario, enabling the system to generate actionable insights, simulate alternative outcomes, or recommend adaptive strategies in response to detected events.

An execution and recommendation module 110 may execute the composed analytic artifact to simulate one or more outcomes and generate a recommendation based on the outcomes. As used herein, a recommendation may refer to an action, adjustment, or decision suggestion derived from the simulated outcome. The recommendation may provide an operational directive or strategic guidance designed to optimize system performance, mitigate identified risks, or exploit emerging opportunities under the contextual conditions associated with the trigger event. Generation of the recommendation may involve evaluating simulated outcomes against predefined performance objectives, operational constraints, or optimization goals, and selecting response strategies that best align with desired outcomes. In some embodiments, a scenario simulation module 112 may be configured to perform one or more conditional simulations (i.e., what-if simulations) by varying input parameters to evaluate multiple potential outcome scenarios. The scenario simulation module 112 may facilitate exploration of various hypothetical conditions, enabling sensitivity analysis, stress testing, or alternative strategy evaluation to support enhanced decision-making and optimization strategies. For example, scenario simulations may include assessing the impact of varying delivery lead times on fulfillment rates, modeling the effects of different supplier substitution strategies on supply chain continuity, or evaluating changes in loan portfolio risk profiles under alternative macroeconomic conditions.

As depicted in FIG. 1, the event processing module 102 may receive qualified trigger events and propagate event payloads to the constraint and feature derivation module 104. In some embodiments, the constraint and feature derivation module 104 may infer contextual decision boundaries and generate relevant feature sets. The knowledge graph traversal module 106 may query a knowledge graph to identify modular assets matching the derived context. In some embodiments, the analytic artifact composition module 108 may construct analytic artifacts by assembling modular assets identified through the traversal. The execution and recommendation module 110 may execute the analytic artifacts to generate simulated outcomes and output one or more recommendations. In some embodiments, the scenario simulation module 112 may perform simulations under varying conditions to evaluate alternative outcomes and to further refine the recommendations presented to a user. The system 100 may enable dynamic, context-aware decisioning, optimization, and simulation processes.

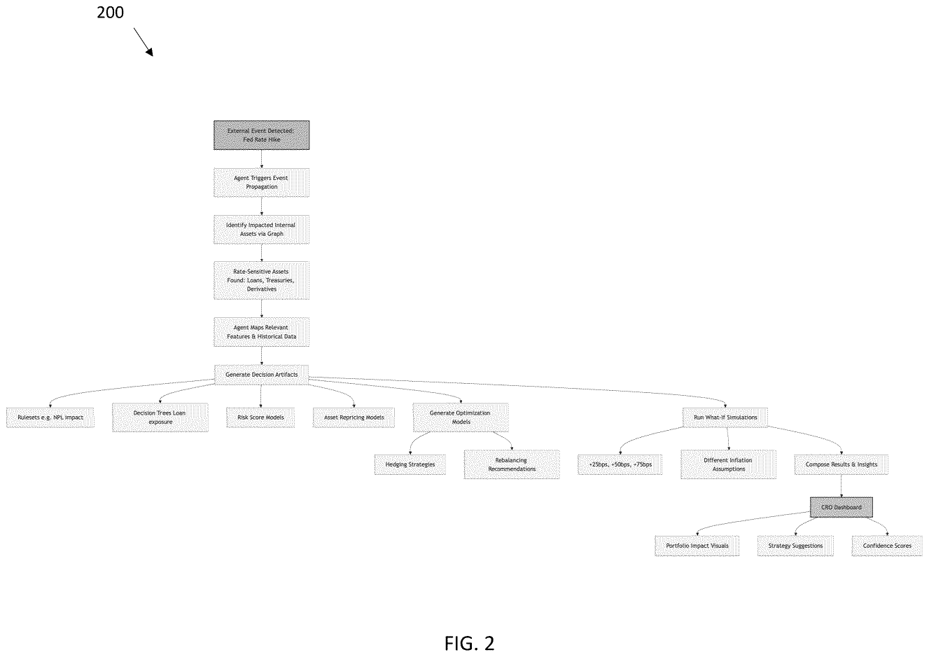

FIG. 2 illustrates an exemplary flow diagram depicting a dynamic event-driven analytic artifact generation and simulation process, in accordance with one or more embodiments of the approach described herein. As shown in FIG. 2, the process may be initiated when an external event is detected, such as a federal interest rate hike. In some embodiments, an event processing module may be configured to monitor external data sources and detect trigger events that meet predefined qualification criteria. Upon detection of the external event, an agent component may trigger event propagation, wherein the event payload containing contextual information related to the detected event is generated and forwarded for further processing. In some embodiments, the event payload may include metadata describing the nature of the event, its timestamp, and associated parameters, such as magnitude of the interest rate change. Following event propagation, the agent may initiate a traversal of a knowledge graph to identify internal assets potentially impacted by the detected event. As used herein, a knowledge graph may refer to a data structure comprising interconnected modular assets, where each node may represent an asset associated with metadata and each edge may represent a defined relationship enabling traversal, path discovery, and contextual relevance determination.

In some embodiments, internal assets identified through the traversal may include, for example, loans, treasury holdings, and derivative instruments that exhibit sensitivity to changes in interest rates. After identifying impacted internal assets, the agent may map relevant features and historical data associated with those assets. For example, features such as interest rate sensitivity, duration, delinquency probability, and historical performance trends may be mapped. In some embodiments, mapping relevant features may facilitate contextual understanding of how the detected event may influence asset behavior. Based on the identified assets and mapped features, the agent may be configured to generate one or more decision artifacts. In some embodiments, decision artifacts may comprise rule sets (e.g., rules modeling non-performing loan impacts), decision trees (e.g., loan exposure classification trees), risk score models (e.g., models predicting default probability), or asset repricing models (e.g., models recalculating asset valuations under new rate assumptions). In addition to generating decision artifacts, the agent may also generate optimization models. For example, optimization models may include hedging strategy models designed to reduce portfolio risk exposure, or rebalancing recommendation models aimed at realigning asset allocations to optimize expected returns under the new economic conditions. In some embodiments, after generation of decision artifacts and optimization models, the system may perform one or more what-if simulations. The scenario simulation module may simulate multiple outcome scenarios by varying input parameters, such as applying different basis point changes (+25 bps, +50 bps, +75 bps) or adjusting inflation assumptions. The what-if simulations may allow the system to evaluate how varying economic conditions could impact internal asset portfolios. Subsequent to running the simulations, the system may compose results and insights for end-user consumption. For example, simulation outcomes and optimization recommendations may be aggregated, organized, and formatted for presentation. In some embodiments, insights may be composed into a structured format suitable for display on a user dashboard, such as a chief risk officer (CRO) dashboard. The CRO dashboard may present several outputs, including portfolio impact visualizations that illustrate projected changes in asset performance, strategy suggestions recommending potential actions (e.g., hedging adjustments, asset reallocations), and associated confidence scores quantifying the reliability of each recommendation based on the quality of historical data and model performance metrics. In some embodiments, the approach described herein may facilitate dynamic, automated, and context-sensitive adaptation of decisioning, optimization, and simulation strategies in response to evolving external or internal signals. By leveraging the modularity of composable assets, event-driven architecture, and agentic-AI capabilities, the system may enable organizations to respond to complex market or operational shifts with enhanced agility and data-driven confidence.

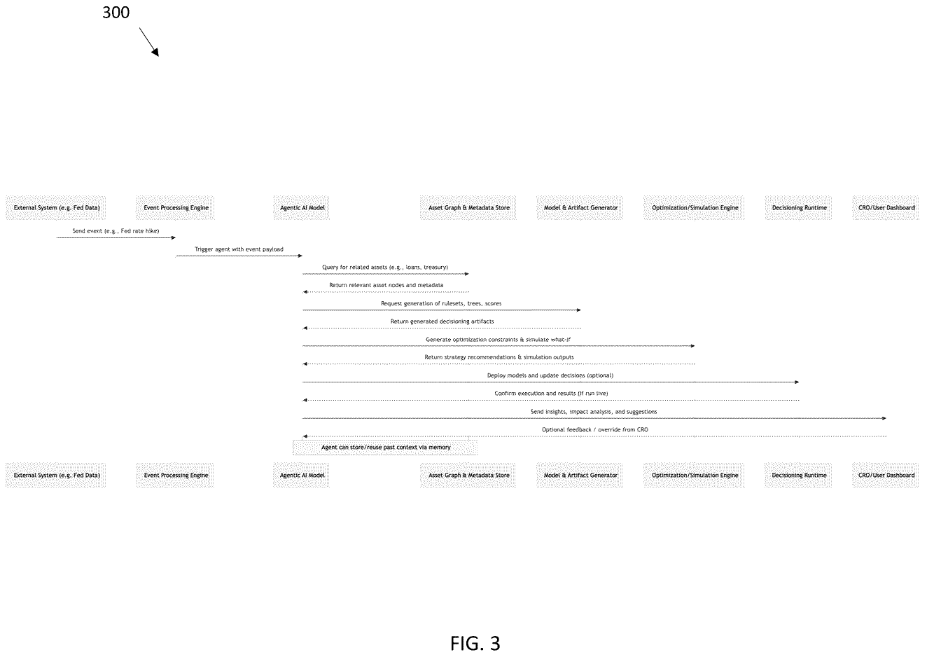

FIG. 3 illustrates an exemplary sequence diagram depicting inter-module interactions for dynamic event-driven analytic artifact generation and decisioning, in accordance with one or more embodiments of the approach described herein. As shown in FIG. 3, the sequence may begin when an external system, such as an economic data provider or financial institution, sends an event notification to an event processing engine. For example, the event may indicate a federal interest rate change or other significant economic signal. In some embodiments, the event processing engine may be configured to receive the event payload and trigger an agentic-AI model by forwarding the event information. The agentic-AI model may be configured to interpret the event context and initiate queries to an asset graph and metadata store. As used herein, the asset graph and metadata store may refer to a structured repository comprising interconnected modular assets and associated metadata enabling graph traversal and asset discovery. Upon querying the asset graph and metadata store, the agentic-AI model may receive a response comprising relevant asset nodes and metadata related to the context of the detected event. For example, the returned assets may include loans, treasury instruments, or derivative products sensitive to interest rate fluctuations. Following asset identification, the agentic-AI model may request the generation of analytic artifacts from a model and artifact generator. In some embodiments, requested artifacts may include rule sets, decision trees, score models, or other predictive analytic models appropriate for addressing the detected event context. The model and artifact generator may return the generated decisioning artifacts to the agentic-AI model. The agentic-AI model may then apply the artifacts to generate optimization constraints and configure scenario-based what-if simulations through an optimization and simulation engine. For example, the optimization process may suggest portfolio rebalancing strategies or hedging adjustments under varying simulated market conditions. The optimization and simulation engine may output strategy recommendations and simulation results to the agentic-AI model. In some embodiments, the agentic-AI model may optionally deploy the resulting models into a decisioning runtime for live execution. Alternatively, the system may be configured to simulate and recommend actions without immediate deployment. If executed live, the decisioning runtime may confirm the results of the execution and report back to the agentic-AI model. The agentic-AI model may then compile and send insights, impact analyses, and strategy suggestions to a CRO/user dashboard. In some embodiments, the CRO dashboard may be configured to present simulation results, portfolio impact visualizations, recommended strategies, and associated confidence scores to an end user such as a chief risk officer. In some embodiments, the CRO or end user may optionally provide feedback or override suggestions through the dashboard interface. The agentic-AI model may incorporate such feedback into subsequent processing, enabling dynamic adaptation and reinforcement learning. Additionally, as shown in FIG. 3, the agentic-AI model may be configured to store and reuse past context information in memory. This memory capability may allow the agentic-AI model to preserve historical state, thereby improving response time, reasoning continuity, and model adaptation efficiency for future events. The sequence illustrated in FIG. 3 highlights a modular and flexible interaction flow among the external event systems, the agentic-AI model, the asset graph traversal components, the model generation modules, the simulation and optimization engines, and the end-user decisioning dashboards, facilitating a dynamic and context-aware analytic and decisioning platform.

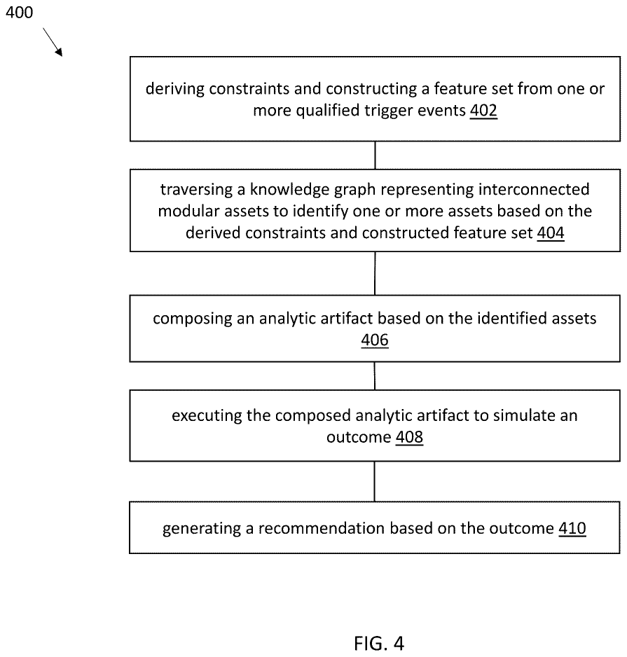

FIG. 4 is a diagram illustrating a flow chart of a process 400 for dynamically generating analytic artifacts and deriving decision recommendations, in accordance with one or more embodiments of the approach described herein. As shown in FIG. 4, the process 400 may begin with operation 402, wherein the system may derive constraints and construct a feature set from one or more qualified trigger events. In some embodiments, a qualified trigger event may refer to an external or internal event meeting predefined conditions sufficient to initiate analytic workflows. For example, a qualified trigger event may include an economic indicator, a regulatory change, or a detected anomaly in operational performance. In some embodiments, deriving constraints may comprise inferring decision-making boundaries based on the context associated with the qualified trigger events, and constructing a feature set may comprise identifying a plurality of data attributes that characterize the relevant context. Next, at operation 404, the system may traverse a knowledge graph representing interconnected modular assets to identify one or more assets based on the derived constraints and constructed feature set. In some embodiments, the “knowledge graph may refer to a data structure comprising nodes representing modular assets (e.g., rulesets, models, datasets) interconnected by defined relationships, thereby enabling traversal, path discovery, and contextual reasoning. The process 400 may proceed to operation 406, wherein the system may compose an analytic artifact based on the identified assets. In some embodiments, an “analytic artifact may comprise one or more of a decisioning artifact, an optimization artifact, or a simulation artifact generated to address the context derived from the qualified trigger events. For example, the analytic artifact may include a risk score model, a ruleset modeling non-performing loan impacts, or an asset repricing model. In some embodiments, the composed analytic artifact may further integrate optimization models, such as hedging strategy generators or rebalancing recommendation engines. At operation 408, the system may execute the composed analytic artifact to simulate an outcome. In some embodiments, the system may further perform one or more conditional simulations (i.e., what-if simulations) by varying input parameters to evaluate multiple potential outcome scenarios. For example, the scenario simulation module may simulate different economic conditions, such as varying interest rate increases or inflation assumptions, to test the resilience of the decisioning strategies. The process 400 may then advance to operation 410, wherein the system may generate a recommendation based on the outcome. In some embodiments, a “recommendation may refer to an action suggestion, an adjustment proposal, or a strategic decision output derived from the simulated outcome. In some embodiments, the recommendation may further be accompanied by explainable reasoning paths tracing back to the qualified trigger events. Additionally, the system may provide a mechanism for receiving user feedback on the generated recommendation and updating the knowledge graph based on the feedback, thereby enabling continuous learning and system adaptation.

The agentic-AI may be trained using a combination of historical operational events, contextualized constraint-feature mappings, knowledge graph traversal records, artifact composition patterns, simulation outcomes under varied scenarios, recommendation adoption feedback, and reinforcement signals derived from user interactions, enabling adaptive reasoning, decision orchestration, and context-aware artifact generation.

In some embodiments, construction of the training set for the agentic-AI may involve multiple stages of data aggregation, preprocessing, contextual labeling, and feature engineering to ensure that the training corpus accurately reflects the operational diversity and decision complexity the system is intended to manage. Training set construction may begin with the aggregation of historical event records from various operational domains, including but not limited to supply chain disruptions, financial market shifts, regulatory changes, and infrastructure outages. Each event record may include associated metadata, such as event type, timestamp, affected entities, geographic impact zones, and operational severity scores, which may be extracted and standardized across heterogeneous data sources. In some embodiments, the aggregated event records may be enriched with contextualized constraint-feature mappings. For each historical event, manual or automated processes may be employed to infer the decision-making constraints that were active during the event response, such as regulatory compliance requirements, service-level agreements, operational safety thresholds, or customer impact tolerances. Simultaneously, relevant feature sets may be identified by extracting observable and derived attributes that characterized the operational state at the time of the event, including inventory levels, financial exposure metrics, supplier reliability indicators, transportation network statuses, or customer sentiment scores. In some embodiments, these constraint-feature mappings may be labeled to reflect the causal relationships between observed operational states, derived constraints, and eventual decision outcomes, providing structured examples for supervised learning.

Following constraint-feature mapping, the training set construction process may incorporate knowledge graph traversal records. In some embodiments, traversal records may capture sequences of graph node and edge selections performed during past operational responses, annotated with context descriptors such as trigger event type, priority level, and traversal objective. Traversal sequences that resulted in successful asset identification and effective mitigation strategies may be labeled as positive examples, while ineffective or suboptimal traversals may be labeled for negative or contrastive learning. The knowledge graph structure itself, including node embeddings, edge metadata, and global topological patterns, may be used as auxiliary inputs to enhance the agentic-AI's ability to reason over graph-structured data. Artifact composition patterns may also form a core component of the training set. In some embodiments, historical instances of analytic artifact generation may be extracted from operational logs, including records of decision trees built, optimization models deployed, and simulation engines configured in response to specific contexts. Each artifact composition instance may be labeled with the underlying assets utilized, the decision constraints imposed, and the objectives pursued, allowing the training set to encode patterns of effective artifact assembly under varied operational conditions. In some embodiments, simulation outcome records may be incorporated by executing or retrieving past what-if scenario simulations associated with historical events. Simulation records may capture how varying input parameters, such as delivery lead times, supplier failure probabilities, interest rate fluctuations, or customer demand surges, influenced predicted operational outcomes. For each simulation instance, outcome metrics such as fulfillment rate deviations, cost increases, regulatory compliance breaches, or customer satisfaction impacts may be recorded. These simulation examples may enable the agentic-AI to learn to anticipate the downstream effects of hypothetical parameter shifts and to select strategies that optimize outcomes under uncertainty.

Recommendation adoption feedback may also be included in the training set. In some embodiments, records of system-generated recommendations and subsequent user actions may be analyzed to determine acceptance, modification, or rejection patterns. Each recommendation may be paired with a feedback label indicating whether the recommendation was accepted as-is, modified before execution, or overridden entirely. Feedback metadata, such as reason codes for rejection or success criteria achieved post-adoption, may be incorporated to refine the agentic-AI's understanding of actionable recommendation generation and user preference modeling. In some embodiments, reinforcement signals derived from operational outcomes may further augment the training set. For example, sequences of decisions leading to favorable operational metrics, such as reduced disruption impact, improved service levels, or cost optimizations, may generate positive reinforcement examples, while sequences associated with adverse outcomes may contribute negative reinforcement signals. These signals may be used to train the agentic-AI using reinforcement learning methods, enabling iterative improvement of decision policies over time. Training set construction may also involve various data augmentation techniques to enhance robustness. In some embodiments, synthetic event records, constraint scenarios, or simulated graph structures may be generated by perturbing real-world examples, allowing the agentic-AI to generalize beyond observed historical conditions. Data balancing strategies may be applied to ensure that rare but critical events, such as catastrophic supply chain failures or systemic financial shocks, are sufficiently represented despite their low natural frequency. In some embodiments, pretraining techniques may be employed, wherein the agentic-AI is initially exposed to large-scale unsupervised learning tasks over the knowledge graph (e.g., node prediction, link prediction, graph embedding learning) before fine-tuning on supervised decision-making tasks. Preprocessing of the training set may involve normalization of numerical features, tokenization or embedding of categorical variables, anonymization of sensitive operational data, and standardization of labeling schemas across different data sources. Feature engineering processes may derive higher-order features, such as rolling averages, trend slopes, or risk composite scores, to enrich the feature space available for training. In some embodiments, the constructed training set may be partitioned into training, validation, and testing subsets according to operational domains, event types, or random sampling strategies, enabling performance benchmarking, overfitting detection, and generalization assessment. Model evaluation may include metrics such as decision accuracy, constraint satisfaction rates, traversal efficiency, artifact assembly precision, simulation outcome fidelity, and recommendation adoption likelihood. Through the comprehensive construction of a multi-source, context-rich training set as described, the agentic-AI may acquire the capability to reason adaptively, traverse knowledge graphs intelligently, compose analytic artifacts dynamically, simulate complex operational scenarios, and generate actionable, context-aware recommendations that evolve in response to feedback and changing operational environments.

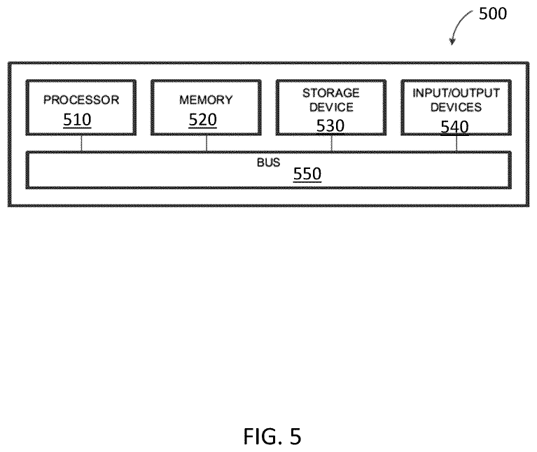

FIG. 5 depicts a block diagram illustrating a computing system 500 consistent with implementations of the current subject matter. As shown in FIG. 5, the computing system 500 can include a processor 510, a memory 520, a storage device 530, and input/output devices 540. The processor 510, the memory 520, the storage device 530, and the input/output devices 540 can be interconnected via a system bus 550. The computing system 500 may additionally or alternatively include a graphic processing unit (GPU), such as for image processing, and/or an associated memory for the GPU. The GPU and/or the associated memory for the GPU may be interconnected via the system bus 550 with the processor 510, the memory 520, the storage device 530, and the input/output devices 540. The memory associated with the GPU may store one or more images described herein, and the GPU may process one or more of the images described herein. The GPU may be coupled to and/or form a part of the processor 510. The processor 510 is capable of processing instructions for execution within the computing system 500. In some implementations of the current subject matter, the processor 510 can be a single-threaded processor. Alternately, the processor 510 can be a multi-threaded processor. The processor 510 is capable of processing instructions stored in the memory 520 and/or on the storage device 530 to display graphical information for a user interface provided via the input/output device 540.

The memory 520 is a computer-readable medium, such as volatile or non-volatile memory, that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, or a tape device, or other suitable persistent storage means. The input/output device 540 provides input/output operations for the computing system 500. In some implementations of the current subject matter, the input/output device 540 includes a keyboard and/or pointing device. In various implementations, the input/output device 540 includes a display unit for displaying graphical user interfaces.

According to some implementations of the current subject matter, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some implementations of the current subject matter, the computing system 500 can be used to execute various interactive computer software applications that can be used for organization, analysis and/or storage of data in various (e.g., tabular) format (e.g., Microsoft Excel®, and/or any other type of software). Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed framework specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software frameworks, frameworks, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

### Use Case 1

A supply chain logistics provider applies the approach described herein to dynamically manage disruptions and optimize fulfillment operations across a distributed network of suppliers, warehouses, and transportation partners. A qualified trigger event occurs when an external system detects a disruption event, such as a major port strike, severe weather conditions impacting regional transport routes, or an unexpected delay reported by a critical supplier. The event processing module receives the trigger event and generates an event payload encapsulating contextual metadata, including the nature of the disruption, affected geographic areas, expected duration, and severity level. The constraint and feature derivation module analyzes the event payload to derive operational constraints that must guide response strategies, such as adjusted delivery time windows, restricted transportation capacity, rerouting imperatives, and dynamic inventory replenishment thresholds. Concurrently, a feature set is constructed by aggregating relevant attributes characterizing the supply chain environment, including current inventory levels across warehouses, historical supplier reliability metrics, transportation mode lead times, per-route risk assessments, and customer order urgency profiles. The knowledge graph traversal module queries a supply chain knowledge graph representing interconnected modular assets, wherein each node represents a discrete operational entity such as a supplier node, a warehouse node, a transportation route node, or a shipment batch node, with metadata indicating operational parameters, capacity limits, interdependencies, and risk factors. Traversal operations identify the holdings and positions most sensitive to the detected disruption, such as specific inventory positions awaiting inbound replenishment, shipment batches queued for delayed routes, and alternative transportation modes with available capacity. The analytic artifact composition module assembles an analytic artifact based on the identified holdings and positions, integrating decisioning artifacts such as alternative supplier selection trees, optimization artifacts such as dynamic routing and transportation mode reallocation models, and simulation artifacts capable of forecasting fulfillment performance under varying disruption scenarios. The execution and recommendation module executes the composed analytic artifact to simulate the impact of different mitigation strategies, evaluating key operational metrics including expected order fulfillment rates, delivery delay probabilities, inventory turnover adjustments, and overall logistics cost variations. Scenario simulations explore a range of parameterized strategies, including rerouting shipments through unaffected ports, shifting last-mile deliveries from road to air, or pre-positioning critical inventory in regional warehouses to hedge against downstream delays. Based on the simulated outcomes, the system generates a recommendation proposing specific operational adjustments designed to optimize supply chain resilience and customer service levels while minimizing cost impacts. The recommendation may include, for example, redirecting high-priority shipment batches to alternative routes with lower congestion risk, expediting air freight for urgent inventory replenishments, activating backup supplier contracts for critical raw materials, or rebalancing warehouse stock levels across regions to buffer against anticipated shortages. The recommendation is accompanied by an explainable reasoning path that traces the detected qualified trigger event through each stage of constraint derivation, feature selection, knowledge graph traversal, analytic artifact execution, and final decision generation, providing traceability and auditability for operational decisions. The CRO dashboard or equivalent operations management interface presents the simulation results and recommendations, including visualizations of expected impacts across fulfillment KPIs, cost projections, and operational risks under different response scenarios. Decision-makers can review the recommended actions, assess trade-offs, and provide feedback or override inputs through the interface. Such feedback may then be used to update the knowledge graph, for example, by adjusting risk ratings of specific transportation routes based on observed real-world delays, modifying supplier reliability scores, or recalibrating lead time assumptions for critical inventory positions, thereby continuously improving the adaptability and intelligence of the platform for future disruption events. Through this dynamic and context-aware decisioning process, the system enables supply chain organizations to respond proactively to external disruptions, maintain higher service levels, and achieve greater operational efficiency and resiliency under volatile conditions.

### Use Case 2

A financial institution implements the approach described herein to dynamically manage interest rate exposure across its investment and lending portfolios. A qualified trigger event is detected when an external system identifies a federal interest rate hike, accompanied by associated metadata such as the percentage change, effective date, and anticipated policy trajectory. The event processing module receives the qualified trigger event and generates an event payload encapsulating this contextual information. Upon receipt of the event payload, the constraint and feature derivation module analyzes the context to derive operational constraints. These constraints define the decision-making boundaries within which risk mitigation strategies must operate. For example, the constraints may specify limits on aggregate portfolio duration, maximum allowable exposure to floating rate instruments, and predefined thresholds for interest rate risk metrics such as Value-at-Risk (VaR) and Earnings-at-Risk (EaR). Simultaneously, the feature set is constructed by selecting relevant attributes from internal data sources, including loan vintage characteristics, credit risk scores, repricing frequencies, historical sensitivity patterns, and macroeconomic covariates. The knowledge graph traversal module accesses a knowledge graph representing interconnected modular assets and performs traversal operations to identify internal holdings and positions most sensitive to interest rate changes. Each node in the knowledge graph corresponds to a holding or position, with metadata attributes such as duration, convexity, interest rate floors or caps, and embedded optionality features. The traversal process identifies key exposures within loan portfolios, bond holdings, and derivatives positions that are materially impacted by the rate adjustment. After identification of relevant holdings and positions, the analytic artifact composition module composes an analytic artifact tailored to the current context. The analytic artifact integrates decisioning artifacts, such as decision trees classifying loans by interest rate sensitivity; optimization artifacts, such as models recommending portfolio rebalancing actions; and simulation artifacts, such as scenario engines projecting cash flow impacts under different rate paths. The execution and recommendation module executes the composed analytic artifact by applying the models to current holdings and positions. Execution includes simulating multiple outcomes, evaluating how key metrics such as Net Interest Income (NII), liquidity buffers, and regulatory capital ratios respond under the projected interest rate environment. Scenario simulations are performed by adjusting input parameters to explore alternative economic assumptions, including varying magnitudes of rate hikes (+25 bps, +50 bps, +75 bps) and shifts in inflation expectations. Based on the execution outcomes, the system generates a recommendation specifying strategic actions to optimize the institution's risk-return profile. The recommendation may include repricing certain loan products, adjusting hedging coverage through swaps or caps, realigning asset allocations in investment portfolios, and modifying funding strategies to minimize margin compression. The recommendation is generated together with an explainable reasoning path that traces the influence of the qualified trigger event through constraint derivation, feature selection, knowledge graph traversal, analytic artifact composition, and simulation execution. The recommendation is surfaced through a CRO dashboard that consolidates simulation outputs into visual impact summaries, strategy suggestions, and associated confidence scores. The dashboard enables decision-makers to review projected portfolio impacts under different scenarios, compare trade-offs between competing strategies, and select preferred courses of action. Additionally, user feedback collected through the dashboard interface may be used to refine system behavior. For example, if the chief risk officer overrides a suggested rebalancing action due to strategic considerations not captured by the models, the feedback may be ingested to update the knowledge graph. Updates may involve adjusting node metadata, modifying relationship weights between holdings, or recalibrating model sensitivity parameters, thereby improving the quality and relevance of future analytic artifacts and recommendations. Through this dynamic process, the system enables the financial institution to respond to external macroeconomic events with increased agility, data-driven precision, and organizational resilience, reducing operational risks and improving overall decision-making effectiveness in rapidly changing market conditions.

### Use Case 3

A regional transmission operator (RTO) implements the approach described herein to dynamically manage ramping, congestion, and reliability risks arising from high renewable penetration and weather-driven variability across a multi-region grid. A qualified trigger event occurs when an external meteorological service and internal telemetry jointly detect an impending wind lull and cloud cover front forecast to reduce net renewable output by 1.8-2.3 GW within the next 45 minutes across two balancing areas, accompanied by elevated line loading on an intertie due to a concurrent unplanned generator outage. The event processing module receives the trigger event and generates an event payload encapsulating contextual metadata including the forecast delta of renewable output, spatial footprint, onset window, uncertainty bounds, intertie identifiers, current contingency status (N-1), and the severity level.

The constraint and feature derivation module analyzes the event payload to derive operational constraints that must guide response strategies, such as: (i) adherence to NERC reliability criteria and local operating limits, (ii) minimum spinning and non-spinning reserve requirements per balancing area, (iii) transmission thermal limits and transient stability constraints on impacted corridors, (iv) ramp-rate ceilings for fast-start and cycling units, (v) emissions caps for peaker dispatch under active permits, and (vi) locational marginal price (LMP) caps per market rules. Concurrently, a feature set is constructed by aggregating attributes that characterize the system state and forecast context, including: net load forecast trajectories, renewable forecast confidence intervals by plant cluster, unit commitment status and start-up times, dynamic line ratings (DLR) on key lines, historical regulation performance for participating resources, state of charge (SoC) and round-trip efficiency for storage fleets, and congestion shadow prices from the most recent market interval.

The knowledge graph traversal module queries a grid operations knowledge graph representing interconnected modular assets and operational entities. Each node represents an asset such as a generating unit (with ramp rates, start costs, emissions factors), a storage resource (with SoC, charge/discharge limits, degradation curves), a demand response (DR) program (with enrolled capacity, activation constraints, customer classes), a transmission element (with limits, DLR profile, protection settings), or a market construct (offer curves, ancillary service participation status). Edges encode relationships such as electrical connectivity, reserve substitution feasibility, co-optimization linkages between energy and ancillary services, and intertie transfer dependencies. Traversal operations identify (i) fast-ramping thermal units within 10-30 minute start horizons, (ii) battery fleets positioned downstream of the congested intertie, (iii) DR aggregations near urban load pockets affected by the renewable shortfall, and (iv) candidate reconfiguration paths leveraging topology control and phase-shifting transformers to alleviate corridor congestion.

The analytic artifact composition module assembles an analytic artifact tailored to the current context by integrating:
Decisioning artifacts: contingency classification rules to determine whether to trigger FRAC (Fast Response Ancillary Capacity), DR stage escalation, or storage priority discharge based on renewable ramp deficit and line loading; voltage security screening criteria for permissibility of topology switching; commitment override rules for critical fast-start resources under scarcity conditions.
Optimization artifacts: a co-optimized unit commitment & economic dispatch (UC/ED) model that jointly clears energy, regulation, spinning and non-spinning reserves under updated constraints; a transmission reconfiguration optimizer with DCOPF approximations and PTDF-based congestion relief; a battery schedule optimizer that considers SoC constraints, degradation cost, and locational needs; and a DR activation scheduler respecting notification times and customer interruption limits.
Simulation artifacts: multi-scenario what-if engines that stress-test outcomes under forecast error bands (P10/P50/P90 renewable output), alternative outage contingencies (N-1-1), and dynamic line rating realizations, producing distributions for unserved energy risk, ACE/regulation performance, LMP volatility, and emissions impact.

The execution and recommendation module executes the composed analytic artifact to simulate outcomes and compute operational and market metrics, including net load following capability, reserve margin compliance, expected congestion costs on the intertie, ramp shortages, LMP dispersion across hubs, emission tonnage projections, battery SoC trajectories, and DR customer impact metrics. Scenario simulations explore response portfolios such as:
1. Storage-first mitigation—front-loading discharge at downstream nodes to relieve intertie flows while backfilling reserves with fast-start units;
2. DR-focused mitigation—activating targeted DR blocks near load pockets to dampen net load ramps;
3. Topology-assisted mitigation—executing a limited set of pre-vetted switching actions plus phase-shifter adjustments to re-route flows; and/or
4. Hybrid mitigation—co-optimizing a mix of fast-start units, storage, limited DR, and minor topology actions to minimize cost under reliability constraints.

Based on simulated outcomes, the system generates a recommendation specifying a time-sequenced operational plan for the next 60 minutes:
T+0-10 min: Initiate discharge of 750 MW from downstream battery fleets with a staged profile to maintain SoC >35%; arm 200 MW of regulation up and 150 MW of spinning reserve in the eastern balancing area; activate topology action Set A (two breaker reconfigurations) to shift 350 MW off the constrained corridor without violating voltage constraints.
T+10-30 min: Commit 600 MW of fast-start aeroderivative units with staggered synchronization; activate 180 MW of DR Tier-1 in two urban zones with 10-minute notification windows; adjust phase-shifting transformer taps to maintain intertie flows <92% of thermal rating.
T+30-60 min: Taper battery discharge to 300 MW as thermal units ramp to setpoint; release 60 MW of additional non-spinning reserves as headroom for forecast uncertainty; evaluate lifting one topology action if post-contingency margins exceed threshold.
The recommendation includes explainable reasoning paths that trace from the qualified trigger event (renewable ramp deficit and intertie congestion) through constraint derivation (reliability, reserves, transmission limits), feature selection (forecasts, SoC, DLR, offers), knowledge graph traversal (asset identification), analytic artifact execution (UC/ED+DCOPF+DR scheduling+battery optimization), and final decision synthesis.

The operator's real-time dashboard presents outcome distributions across scenarios—e.g., probability of ramp shortfall, LMP bands, congestion rent, emissions deltas relative to baseline—and confidence scores derived from forecast quality and model backtests. Grid operators can review, accept, modify, or override specific actions (e.g., reduce DR call from 180 MW to 120 MW to respect customer fatigue constraints, or prioritize a different storage cluster due to local voltage support needs). User feedback is ingested to update the knowledge graph, adjusting metadata such as DR responsiveness factors, storage degradation cost curves, dynamic line rating reliability weights, and unit start success probabilities, thereby improving future asset selection and artifact assembly for similar renewable variability events.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B”; “one or more of A and B”; and “A and/or B” are each intended to mean “A alone, B alone, or A and B together.” A similar interpretation is also intended for lists including three or more items. For example, the phrases “at least one of A, B, and C”; “one or more of A, B, and C”; and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
deriving constraints and constructing a feature set from one or more qualified trigger events;
traversing a knowledge graph representing interconnected modular assets to identify one or more assets based on the derived constraints and constructed feature set;
composing an analytic artifact based on the identified assets, wherein the analytic artifact comprises a decisioning artifact, an optimization artifact, or a simulation artifact;
executing the composed analytic artifact to simulate an outcome; and
generating a recommendation based on the outcome.

2. The method of claim 1, wherein the constraints comprise decision-making boundaries based on a context associated with the qualified trigger events.

3. The method of claim 2, wherein the feature set comprises a plurality of data attributes that characterize the context associated with the qualified trigger events.

4. The method of claim 1, wherein the knowledge graph comprises a data structure representing interconnected nodes and edges, wherein each node represents a modular asset associated with metadata and each edge represents a defined relationship between two assets, enabling traversal, path discovery, and contextual reasoning over the modular assets.

5. The method of claim 1, further comprising performing one or more scenario simulations using the composed analytic artifact to evaluate multiple outcome scenarios responsive to varying input parameters.

6. The method of claim 1, further comprising providing an explainable reasoning path tracing from the one or more qualified trigger events to the recommendation.

7. The method of claim 1, further comprising updating the knowledge graph based on user feedback received on the recommendation.

8. A system comprising:
a programmable processor; and
a non-transient machine-readable medium storing instructions that, when executed by the processor, cause the at least one programmable processor to perform operations comprising:
deriving constraints and constructing a feature set from one or more qualified trigger events;
traversing a knowledge graph representing interconnected modular assets to identify one or more assets based on the derived constraints and constructed feature set;
composing an analytic artifact based on the identified assets, wherein the analytic artifact comprises a decisioning artifact, an optimization artifact, or a simulation artifact;
executing the composed analytic artifact to simulate an outcome; and
generating a recommendation based on the outcome.

9. The system of claim 8, wherein the constraints comprise decision-making boundaries based on a context associated with the qualified trigger events.

10. The system of claim 9, wherein the feature set comprises a plurality of data attributes that characterize the context associated with the qualified trigger events.

11. The system of claim 8, wherein the knowledge graph comprises a data structure representing interconnected nodes and edges, wherein each node represents a modular asset associated with metadata and each edge represents a defined relationship between two assets, enabling traversal, path discovery, and contextual reasoning over the modular assets.

12. The system of claim 8, wherein the operations further comprise performing one or more scenario simulations using the composed analytic artifact to evaluate multiple outcome scenarios responsive to varying input parameters.

13. The system of claim 8, wherein the operations further comprise providing an explainable reasoning path tracing from the one or more qualified trigger events to the recommendation.

14. The system of claim 8, wherein the operations further comprise updating the knowledge graph based on user feedback received on the recommendation.

15. A computer program product comprising a non-transient machine-readable medium storing instructions that, when executed by at least one programmable processor, cause the at least one programmable processor to perform operations comprising:
deriving constraints and constructing a feature set from one or more qualified trigger events;
traversing a knowledge graph representing interconnected modular assets to identify one or more assets based on the derived constraints and constructed feature set;
composing an analytic artifact based on the identified assets, wherein the analytic artifact comprises a decisioning artifact, an optimization artifact, or a simulation artifact;
executing the composed analytic artifact to simulate an outcome; and
generating a recommendation based on the outcome.

16. The computer program product of claim 15, wherein the constraints comprise decision-making boundaries based on a context associated with the qualified trigger events.

17. The computer program product of claim 16, wherein the feature set comprises a plurality of data attributes that characterize the context associated with the qualified trigger events.

18. The computer program product of claim 15, wherein the knowledge graph comprises a data structure representing interconnected nodes and edges, wherein each node represents a modular asset associated with metadata and each edge represents a defined relationship between two assets, enabling traversal, path discovery, and contextual reasoning over the modular assets.

19. The computer program product of claim 15, wherein the operations further comprise performing one or more scenario simulations using the composed analytic artifact to evaluate multiple outcome scenarios responsive to varying input parameters.

20. The computer program product of claim 15, wherein the operations further comprise providing an explainable reasoning path tracing from the one or more qualified trigger events to the recommendation.
